(19) United States
(12) Patent Application Publication
(10) Pub. No.: US 2026/0298628 A1
(43) Pub. Date: Oct. 1, 2026

(54) LEVELLING APPARATUS AND METHOD

(71) Applicant: Tru 2 Level Ltd, Glasgow (GB)

(72) Inventor: Alexander Martin, Kilsyth (GB)

(21) Appl. No.: 19/476,341

(22) PCT Filed: Apr. 19, 2024
(86) PCT No.: PCT/GB2024/051018

§ 371 Date: Oct. 17, 2025

(30) Foreign Application Priority Data
Apr. 19, 2023 (GB) 2305750.8

(51) Int. Cl. G01C 9/02; G01C 15/00

(52) U.S. Cl. CPC G01C 9/02; G01C 15/004

(57) ABSTRACT

A levelling apparatus for preparing a surface to be levelled includes a levelling member and a measurement apparatus. The measurement apparatus includes a body portion, an engagement member for engaging a surface, the engagement member located at an end of the body portion. The measurement apparatus is operable to measure a first distance between a reference level and a first point of a surface to be levelled, and a second distance between the reference level and a second point of the surface to be levelled, and the an offset between the first distance and the second distance. The levelling member is configured, in use when located on the surface, to reduce or eliminate the offset between the first and second distances.

### FIELD OF THE INVENTION

The present invention relates to a levelling apparatus particularly, but not exclusively, to a levelling apparatus for indicating a desired level of a surface, such as a floor.

### BACKGROUND TO THE INVENTION

Before installing flooring, such as wood flooring, or decking, it is often necessary to level a surface, to make the resultant flooring level. Known levelling techniques typically involve applying a levelling agent to the surface to be levelled, to reduce the unevenness and make it more level.

However, without wishing to be bound by theory, known levelling techniques are not thought to result in a true level surface. For example, if a surface to be levelled is slightly sloped, applying a fluid levelling agent to a surface that has undulations, divots, etc., will mean that the resultant surface is not truly level. Furthermore, it is difficult in such circumstances to apply the correct amount of levelling agent to each point, region or section of the surface to provide a truly level surface.

It would be desirable to find a way to level a surface in a more effective manner.

The inventor has appreciated the shortcomings in known levelling techniques and associated tools for levelling surfaces.

### STATEMENTS OF INVENTION

According to a first aspect of the present invention there is provided a levelling apparatus for preparing a surface to be levelled, the apparatus comprising:
a levelling member;
a measurement apparatus comprising:
   a body portion;
   an engagement member for engaging a surface, the
   engagement member located at an end of the body portion;
wherein the measurement apparatus is operable to measure:
   a first distance between a reference level and a first point of
   a surface to be levelled; and
   a second distance between the reference level and a second point of the surface to be levelled; and
   the offset between the first distance and the second distance;
      wherein the levelling member is configured, in use when located on the surface, to reduce or eliminate the offset between the first and second distances.

The levelling member is for preparing the surface to be levelled. The levelling member is a level indicator member for indicating a desired level of the surface on which the levelling member is located.

The levelling apparatus may comprise a plurality of levelling members.

The levelling member may be a spacer.

The measurement apparatus and the levelling member may be separate.

The surface, or portion thereof, may be levelled using a levelling agent (e.g. floor leveller or levelling screed) as is known in the art of surface levelling.

The surface to be levelled may be planar or non-planar and may be unlevel with respect to the reference level. The surface to be levelled may include one or more sloped portions, undulating portions, divots, bumps, or the like.

The first point of the surface may be a substantially planar point of the surface. The second point of the surface may be a substantially planar point of the surface.

The first point and the second point may be of any desired dimensions. In some examples, the first and second points may be points, regions, sections, lines, areas, or the like, on the surface. In some examples, the first point and the second point may each be on the order of less than 10 cm², but any suitable size of point can be used.

The surface to be levelled is a floor or portion thereof, or a portion of the ground, or a deck/decking or portion thereof, or a foundation or portion thereof, or any suitable surface to be levelled.

The body portion of the measurement apparatus may comprise a longitudinal axis. The body portion may comprise a horizontal axis and a lateral axis. The longitudinal, horizontal and lateral axes may be orthogonal. The longitudinal axis may be arranged perpendicular to the surface, or substantially perpendicular thereto, when the body portion is engaged with the surface.

The measurement apparatus may be operable to indicate a distance from the surface. The measurement apparatus may be operable to indicate the first distance and/or the second distance. The measurement apparatus may include a measurement indicator or measurement indicia for indicating a distance from the surface. The measurement indicator or indicia may, in use, indicate the first distance and/or the second distance. The measurement indicator or indicia may be located at or on the body portion of the measurement apparatus. The measurement indicator or indicia may be located at or on an outer part of the body portion. The measurement indicia may be a graduated scale, or the like. The measurement indicia may be arranged along the longitudinal axis of the body portion. The measurement indicia may be arranged along at least a part of the body portion.

The body portion of the measurement apparatus may be elongate. The body portion may be cylindrical. The body portion may be elongate in the direction of the longitudinal axis thereof.

The engagement member may be substantially flat. The engagement member may be configured for engaging a substantially planar portion of the first point of the surface and/or the second point of the surface. The engagement member may be configured to abut a planar portion of the surface when engaged therewith. The engagement member may be integral with the body portion. The engagement member may be a disc-shaped member, which may be a flat disc-shaped member, a circular shaped member, a square shaped member, a rectangular shaped member, or the like. The engagement member may be arranged orthogonal to the longitudinal axis of the body portion. The engagement member may be a planar member arranged on the horizontal-lateral plane of the body portion.

The engagement member may be defined by one or more ends of a wall or walls of the body portion of the measurement apparatus. The engagement member may define a terminal end of the body portion.

The engagement member may be configured to increase the stability of the body portion in the direction of at least one axis of stability, optionally at least two axes of stability, when the engagement member is engaged with the surface. The axis of stability may be at least one of: the horizontal axis and the lateral axis.

### The engagement member may be an abutment member.

The engagement member may be formed from a single engagement member or multiple engagement members.

The measurement apparatus may comprise a reference marker. The reference marker may be configured to indicate the position of the reference level. The reference marker may be operable, in use, to indicate the position of the reference level on the measurement apparatus, or on the body portion thereof.

The measurement apparatus may comprise a single reference marker or a plurality of reference markers.

The reference marker may be separate to the body portion. The reference marker may be engageable with and connectable to the body portion. The reference marker may be configured to be movable along the body portion to indicate the position of the reference level. The reference marker may be movable along at least one axis of the body portion. The reference marker may be movable along the longitudinal axis of the body portion.

The reference marker may be movable relative to the engagement member. The reference marker may be slidably engageable with the body portion.

The reference marker may be reversibly securable in position to indicate the reference level. The reference marker and/or the measurement apparatus may comprise a securing mechanism for securing the reference marker to the measurement apparatus.

The reference marker may include a collar member, or a sleeve, or the like. The reference marker may have a complementary shape to the body portion. The reference marker may be a cylindrical member.

The reference marker may include one or more reference indicators for indicating the reference level. The reference indicator may be an aperture, hole, orifice, or notch, or the like, in the reference marker for indicating the position of the reference level. Any suitable reference indicator can be used.

The measurement apparatus and/or the reference marker may be configured to indicate a distance from the reference level. The measurement apparatus and/or the reference marker may be configured to indicate the first distance and/or the second distance. The measurement apparatus and/or the reference marker may be configured to indicate the offset between the first distance and the second distance. The reference marker may include a measurement indicator or measurement indicia for indicating a distance from the reference level. The measurement indicia may be a graduated scale, or the like. The measurement indicia may be arranged above and/or below the position of the reference indicator. The measurement indicia of the reference marker may be arranged, in use, along the longitudinal axis of the body portion of the measurement apparatus. The measurement indicia of the reference marker may be arranged along the same direction as the measurement indicia of the measurement apparatus.

The measurement apparatus and/or the reference marker may include a measurement indicator or indicia for indicating distance or distances from the reference level.

The measurement apparatus may be configured to measure a straight distance. The straight distance may be along the longitudinal axis of the body portion. The first distance may be a straight distance. The second distance may be a straight distance. The offset may be a straight distance.

The first distance may be along the longitudinal axis of the body portion. The second distance may be along the longitudinal axis of the body portion. The offset may be along the longitudinal axis of the body portion.

The levelling apparatus may comprise a reference level device. The reference level device may be operable to provide the reference level. The reference level device may be an optical device, such as a laser device, a laser spirit level device, or the like. The reference level device may be configured to be mountable on a support structure, such as a wall. The reference level device may be operable to provide a line reference level along an axis, or a plane reference level along a plane. The reference level may be an optical reference level.

The reference level may be spaced from the surface. The reference level may be a horizontal level, which may be a substantially true horizontal level. The longitudinal axis of the body portion may be arranged, in use to be substantially perpendicular to the reference level when engaged with the surface.

The longitudinal axis of the body portion may be arranged substantially vertically when the body portion is engaged with the surface.

The longitudinal axis of the body portion may be normal to the surface when engaged therewith.

The reference level may be along an axis perpendicular to the longitudinal axis of the body portion, or the reference level may be on a horizontal plane perpendicular to the longitudinal axis of the body portion. The reference level device may be operable to illuminate the reference level on the measurement apparatus.

The levelling member may comprise a body portion.

The levelling member may comprise a base for engaging with the surface to be levelled. The base may be a planar base. The base may be securable to the surface. The base may comprise a securing member for securing the base to the surface. The securing member may be an adhesive. The securing member may be a surface penetrating member. The securing member may be an adhesive or a surface penetrating member, or any suitable securing member. The surface penetrating member may be a spike member, or the like.

The levelling member may comprise a level indicator configured to indicate a desired level of the surface. The level indicator may be a planar member.

The levelling member may be configured to remain secured to the surface, in use, when the levelling agent is applied to the surface. The levelling member may be configured to remain secured to the surface, in use, when the levelling agent has set.

The base and the level indicator of the levelling member may be located at opposing ends of the body portion thereof.

The levelling member may be a shim, block, pad, or the like. The levelling member may be rigid.

The levelling member may be configured to be adjustable between a first height and a second height. At the second height, the distance between the level indicator and the base may be greater than at the first height.

The body portion of the levelling member may comprise a longitudinal axis. The levelling member may be height adjustable along the longitudinal axis of the body portion thereof.

The levelling member may comprise an adjustment mechanism for adjusting the height thereof. The adjustment mechanism may be configured to adjust the spacing between the level indicator and the base. The adjustment mechanism may include a screw thread, or the like.

The levelling apparatus may comprise one or more first levelling members. The levelling apparatus may comprise one or more second levelling members. The first levelling member may be height adjustable. The second levelling member may have a fixed height.

The levelling member may be configured to be stackable on at least one other levelling member. The base of the levelling member may be stackable on the level indicator of the other levelling member and/or the level indicator of the levelling member may be stackable with the base of the other levelling member.

The first levelling member may be stackable on the second levelling member and/or the second levelling member may be stackable on the first levelling member.

The levelling apparatus may comprise two or more stackable levelling members.

The stacking of the levelling members may be along the longitudinal axis of the body portion of each levelling member.

The measurement apparatus may be operable to measure a third distance between the levelling member and the reference level. The third distance may be measured when the levelling member is located on the surface. The third distance may be from the level indicator to the reference level. The measurement apparatus may be operable to measure the offset between the third distance and the first distance and/or the offset between the third distance and the second distance. The third distance may be a straight distance. The third distance may be along the longitudinal axis of the body portion of the measurement apparatus.

The engagement member of the measurement apparatus may be configured for abutment, in use, with the levelling member. The measurement apparatus may be operable to measure the third distance when the engagement member is in abutment with the levelling member. The measurement apparatus may be operable to adjust the height of the levelling member. The measurement apparatus may be configurable to be engageable with the levelling member. The measurement apparatus may be engageable with the levelling member. The measurement apparatus may be configured to be temporarily securable to the levelling member when engaged therewith.

The measurement apparatus may be operable, in use, to engage with and adjust the adjustment mechanism of the levelling member. The measurement apparatus may be operable, in use, to adjust the height of the levelling member between the first height and the second height.

The measurement apparatus may be operable, in use, to apply a torque to the adjustment mechanism of the levelling member. Applying a torque may be carried out, in use, by rotating the measurement apparatus about an axis of rotation when the measurement apparatus is engaged with the levelling member. The axis of rotation may be the longitudinal axis of the body portion of the measurement apparatus. Applying a torque may be carried out when the levelling member is secured to the surface. The adjustment mechanism may be configured such that application of a torque thereto adjusts the height of the levelling member.

The height of the levelling member may be adjustable up or down, such that the height can be increased or decreased.

The measurement apparatus may be configured to be releaseably engageable with the levelling member.

The measurement apparatus may comprise an adjustment element for operating the adjustment mechanism. The adjustment element may be configured to operate the adjustment mechanism by engaging with and applying a torque thereto.

The adjustment element of the measurement apparatus may be located at an end of the body portion of the measurement apparatus. The adjustment element of the measurement apparatus may be located at the same end of the body portion as the engagement member. The adjustment element may be located adjacent to the engagement member. The levelling member may include an adjustment element receiving portion. The adjustment element may include one or more protrusions for engaging with the levelling member. The levelling member may include one or more corresponding protrusion receiving portions.

The measurement apparatus may be operable to configure the adjustment element between a withdrawn state and a deployed state. In the withdrawn state, the adjustment element may be contained within the body portion of the measurement apparatus. In the withdrawn state, the adjustment element may be arranged to be level with or a distance behind the engagement member of the measurement apparatus. In the deployed state, the adjustment element may be arranged to protrude from the body portion of the measurement apparatus. In the deployed state, the adjustment element may be arranged to protrude beyond the engagement member of the body portion of the measurement apparatus.

The adjustment element may be configured to protrude in the direction of an axis of the body portion of the measurement apparatus, which may be the longitudinal axis.

In the deployed state, the protrusion(s) of the adjustment element may be configured to protrude beyond the body portion of the measurement apparatus.

The body portion may include a cavity for housing the adjustment element. The body portion may include an opening to the cavity at an end thereof. The engagement member may define, at least in part, an opening to the cavity.

At least a part of the body portion of the measurement apparatus may be hollow. The cavity may be defined by a hollow part of the body portion.

The measurement apparatus may be operable to measure the third distance when the adjustment element is engaged with the levelling member. The measurement apparatus may be operable to measure the third distance when the adjustment element is in the deployed state.

The measurement apparatus may comprise a control operable to configure the adjustment element between the withdrawn state and the deployed state. The control may be operable to fix the adjustment element in the withdrawn state and/or to fix the adjustment element in the deployed state. The control may be a manual control. The manual control may be hand-operable. The control may include an operating element. The operating element may be located at an end of the body portion of the measurement apparatus. The operating element may be located at an opposite end of the body portion to the engagement member. The operating element may include a grip member. The operating element may be at least partially rotatable about an axis of the body portion for configuring between the withdrawn state and the deployed state. The axis may be the longitudinal axis.

The control may include a biasing element. The biasing element may be configured to assist in the movement of the adjustment element from the deployed state to the withdrawn state. The biasing element may include one or more springs, compression springs, or the like. The biasing element may be located within the body portion. The biasing element may be configured to bias the adjustment element towards the withdrawn state. The adjustment mechanism of the levelling member may include one or more adjustment members for operating the adjustment mechanism. The adjustment element of the measurement apparatus may be configured to be engageable with an adjustment member of the levelling member. The adjustment member may be a screw head member, screw drive member, or the like.

The adjustment mechanism of the levelling member may be a manual adjustment mechanism. The manual adjustment mechanism may be operable by hand or by the measurement apparatus.

The measurement apparatus may be operable to detect the first distance and/or the second distance. The measurement apparatus may be operable to detect the third distance. The measurement apparatus may be operable to automatically detect the first distance and/or the second distance, and/or the third distance.

The measurement apparatus may comprise a reference detector configured to detect the reference level. The reference detector may be configured to detect the reference level from the reference level device. The reference detector may be an optical detector, optionally a laser light detector, optionally a visible light or visible laser light detector. The reference marker may comprise the reference detector. The reference detector may be at least a part of the reference marker. The reference detector may be fixed to the reference marker. The reference detector may be separate to the body portion of the measurement apparatus. The reference detector may be engageable with and connectable to the body portion of the measurement apparatus. The reference detector may be configured to be movable along the body portion to detect the position of the reference level. The reference detector may be movable along at least one axis of the body portion. The reference detector may be movable along the longitudinal axis of the body portion. The reference detector may be movable relative to the engagement member. The reference detector may be slidably engageable with the body portion.

The measurement apparatus may comprise a distance detector configured to measure the first distance and/or the second distance. The distance detector may be configured to measure the third distance. The distance detector may comprise or may be one or more height detectors. The distance detector may be an electronic device.

At least a part of the distance detector may be formed on the reference marker. The distance detector may move with the reference marker. The reference marker may comprise the distance detector. The distance detector may be at least a part of the reference marker. The distance detector may be substantially fixed to the reference marker. At least a part of the distance detector may be separate to the body portion of the measurement apparatus. At least a part of the distance detector may be engageable with and connectable to the body portion. The distance detector may be configured to be movable along the body portion to detect the first distance and/or the second distance, and/or optionally the third distance. The distance detector may be movable along at least one axis of the body portion. The distance detector may be movable along the longitudinal axis of the body portion. The distance detector may be movable relative to the engagement member. The distance detector may be slidably engageable with the body portion.

The measurement apparatus may be operable to detect the first distance and/or the second distance using data from the reference detector. The measurement apparatus may be operable to detect the first distance and/or the second distance using data from the distance detector. The measurement apparatus may be operable to detect the first distance and/or the second distance using data from the reference detector and/or data from the distance detector.

The measurement apparatus may be operable to detect the first, second and/or third distances using data from the reference detector and data from the distance detector.

The measurement apparatus may comprise a processor.

The processor may be operable to calculate the offset between the detected first distance and the detected second distance. The processor may be operable to calculate the offset between the detected third distance and the detected first distance, and/or the offset between the detected third distance and the detected second distance.

The measurement apparatus may comprise a communication element. The communication element may be operable to transmit the detected first distance, the detected second distance, and/or the calculated offset therebetween, to a user device. The communication element may be operable to transmit the detected third distance and/or the offset between the third and first distances, or third and second distances.

The user device may be a computing device, such as a smartphone, a laptop, a PC, a tablet, or the like.

The communication element may be configured for wireless communication with the user device. The communication element may be operable to pair with the user device. The communication element may be configured for wireless communication with the user device by at least one wireless communication protocol, such as Bluetooth (RTM), Wifi (RTM) or the like.

The communication element may be operable to communicate with the reference level device. The communication element may be configured for wireless communication with the reference level device. The communication element may be configured for wireless communication with the reference level device by at least one wireless communication protocol, such as Bluetooth (RTM), Wifi (RTM) or the like.

The measurement apparatus may comprise a positioning system configured to infer the position of the measurement apparatus relative to the reference level device. The inferred position may be the offset in the horizontal plane. The inferred position may be accurate to about 200 mm or less, or any suitable accuracy. The positioning system may use received signal data by the communication element from the reference level device to, at least in part, infer the position of the measurement apparatus.

The measurement apparatus may be operable to transmit the inferred position to the user device. The measurement apparatus and/or the user device may be configured to associate one or more distance values, and/or one or more offset values, with each inferred position to build an array of coordinates of measurements.

The user device may be operable to record an initial point of the surface to be levelled, which may be substantially the highest point of the surface to be levelled.

The user device may be operable to generate a template set of points to be levelled. The template may include the initial point, and one or more further points to be levelled. The template may be a grid. The user device may include user input field(s) to determine the template. The user device may be operable to determine when the inferred position of the measurement apparatus is sufficiently close (e.g. within a pre-set tolerance) to the point of the template.

The user device may comprise one or more levelling modes.

In a first levelling mode, the user device may be operable to receive measurements from the measurement apparatus, and to record one or more distances and/or offsets for each coordinate point on the surface to be levelled. The offsets may be received from the measurement apparatus or calculated by the user device based on received distance measurements.

In a second levelling mode, the user device may be operable to determine the offset between each second distance and the first distance. The user device may record each desired offset for each coordinate of the surface to be levelled. The user device may be operable to receive input from the user to determine, at least in part, the desired offsets. The second operating mode may be configured to allow one or more gradients to be input to the user device. The, or each gradient may be measured along a horizontal direction. The, or each gradient may be measured from the initial point of the surface to be levelled. The one or more gradients may be negative (sloping downwards), positive (sloping upwards), or combination thereof. The one or more gradients may be substantially linear (e.g. 1:80, or the like).

The measurement apparatus may be operable to communicate with a further measurement apparatus.

The further measurement apparatus may comprise one or more, or substantially all, of the same features of the measurement apparatus as described herein.

The communication element of the measurement apparatus may be operable to communicate with the further measurement apparatus. The measurement apparatus may be operable to transmit and/or receive distance data and/or offset data, to/from the further measurement apparatus. The measurement apparatus may be operable to transmit/receive the initial point of the surface to be levelled to/from the further measurement apparatus.

The levelling apparatus may comprise the further measurement apparatus, or a plurality of further measurement apparatus.

The further measurement apparatus may be operable to transmit detected distance(s)/offsets from the further measurement apparatus to the user device.

The measurement apparatus may be operable to transmit distance/offset data, received from the further measurement apparatus, to the user device. The further measurement apparatus may be operable to transmit distance/offset data, received from the measurement apparatus, to the user device.

In a third levelling mode, the user device may be operable to apply a global offset to the coordinates of points of the surface to be levelled. The user device may be operable to apply a local offset to one or more of the coordinates of points based, at least in part, on a threshold level.

The user device may be operable to calculate the volume of levelling agent, or volume of levelling agents (e.g. floor leveller or levelling screed) required. The user device may be operable to display the calculated volume of levelling agent, or levelling agents.

The user device may be operable to receive user input on the type of surface to be levelled. This may include a list of one or more substrates, such as timber, concrete, ceramic, stone, underfloor wet or electric heating, or the like. The type of substrate may be the bulk substrate and/or the surface finish thereof.

The user device may be operable to receive user input on the humidity of the room or environment in which levelling is to take place.

The user device may be operable to display one or more suitable types of levelling agent, which in some examples may include item(s) orderable from one or more suppliers. The user device may be operable to permit the user to purchase or order one or more of the displayed suitable levelling agents.

The user device may be operable to run application software configured, when run, to carry out one or more of the functions of the user device described herein.

According to a second aspect of the present invention there is provided a measurement apparatus comprising:
a body portion; and
an engagement member for engaging a surface, the engagement
member located at an end of the body portion;
   wherein the measurement apparatus is operable to measure:
a first distance between a reference level and a first point of a surface to be levelled; and
a second distance between the reference level and a second point of the surface to be levelled; and
the offset between the first distance and the second distance.

According to a third aspect of the present invention there is provided a measurement apparatus comprising:
a body portion; and
an engagement member for engaging a surface, the engagement
member located at an end of the body portion; and
   wherein the measurement apparatus is operable to measure the distance between a reference level and the surface.

According to a fourth aspect of the present invention there is provided a levelling member for preparing a surface to be levelled, the levelling member comprising:
a body portion;
a base for engaging with a surface to be levelled; and
a level indicator configured to indicate a desired level of the surface; and
   wherein the base and the level indicator are located at opposing ends of the body portion.

According to a fifth aspect of the present invention there is provided a method for preparing a surface to be levelled, the method comprising the steps of:
(i) providing a reference level;
(ii) measuring a first distance between the reference level and a first point of a surface to be levelled;
(iii) measuring a second distance between the reference level and a second point of the surface to be levelled;
(iv) determining the offset between the first distance and the second distance;
(v) providing a levelling member to the second point of the surface, the levelling member being configured, in use when located on the surface, to reduce or eliminate the offset; and
(vi) securing the levelling member to the surface.

The steps of the method may be carried out in any order unless the context provides otherwise.

Embodiments of any of the first to fifth aspects of the present invention may include one or more features of the other aspects of the present invention or their embodiments.

### BRIEF DESCRIPTION OF THE DRAWINGS

Embodiments of the invention will now be described, by way of example, with reference to the drawings, in which:

FIGS. 1a and 1b show a measurement apparatus 6 of a levelling apparatus 1, both in accordance with an embodiment of the invention, with the levelling apparatus 1 engaged with a first point 2a on the surface 2;

FIG. 1c shows the measurement apparatus 6 of FIG. 1a, when engaged with a second point 2b of the surface;

FIGS. 1d and 1e show the measurement apparatus 6 of FIG. 1 when engaged with further points of the surface 2;

FIG. 2 shows the levelling apparatus of FIG. 1a when used with a second levelling member 4″;

FIG. 3a shows a reference level device 12 providing a reference level 8;

FIGS. 3b and 3c show the reference marker 10 of the measurement apparatus 6 in more detail and how it is used with the reference level 8;

FIGS. 4a to 4i illustrate the stages of using the levelling apparatus 1 at the second point 2b of the surface 2, to secure a levelling member 4 thereto;

FIG. 5 depicts a number of levelling members 4 secured to the surface 2 to be levelled;

FIGS. 6a and 6b show an adjustable first levelling member 4′ in accordance with an embodiment of the invention;

FIG. 7 shows a non-adjustable second levelling member 4;

FIG. 8 shows a levelling member 4 secured to the surface and with a levelling agent having been applied;

FIGS. 9a to 9c show another embodiment of the measurement apparatus 6;

FIGS. 10a and 10b show before and after images of the application of levelling agent to the surface 2, with the levelling members 4 present thereon; and

FIGS. 11a to 11c show a modified embodiment of the measurement apparatus 6 of FIG. 9a, with a cut-away portion showing the location of the biasing element 6k;

FIG. 12 shows an alternative embodiment of the measurement apparatus 6′;

FIG. 13 shows the measurement apparatus 6′ of FIG. 12 in use;

FIGS. 14a to 14c show a user device 16 for use with the measurement apparatus of FIG. 12;

FIG. 15 shows another use of the measurement apparatus 6′ of FIG. 12.

### DESCRIPTION OF PREFERRED EMBODIMENTS

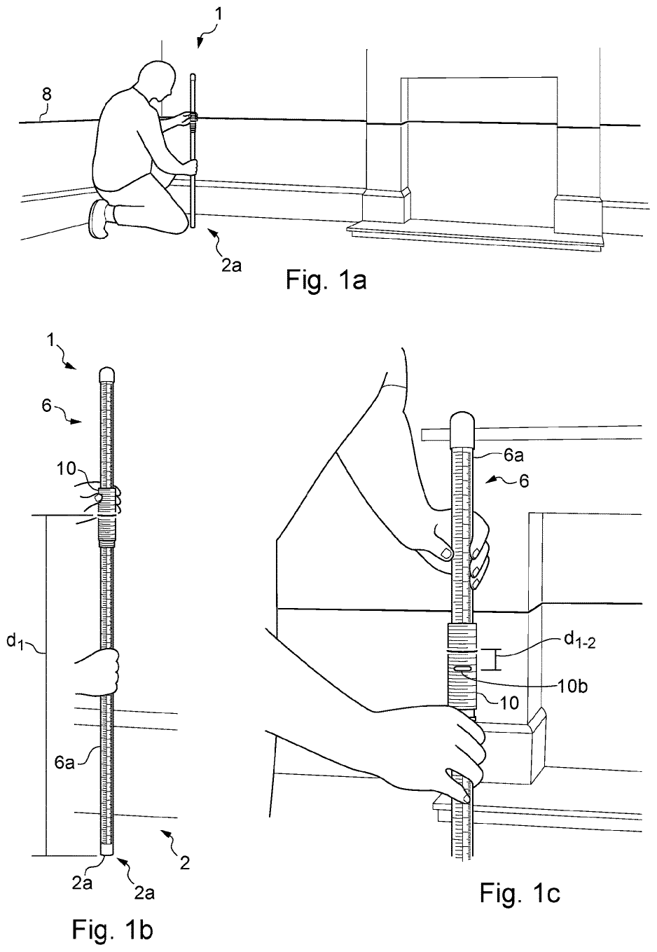

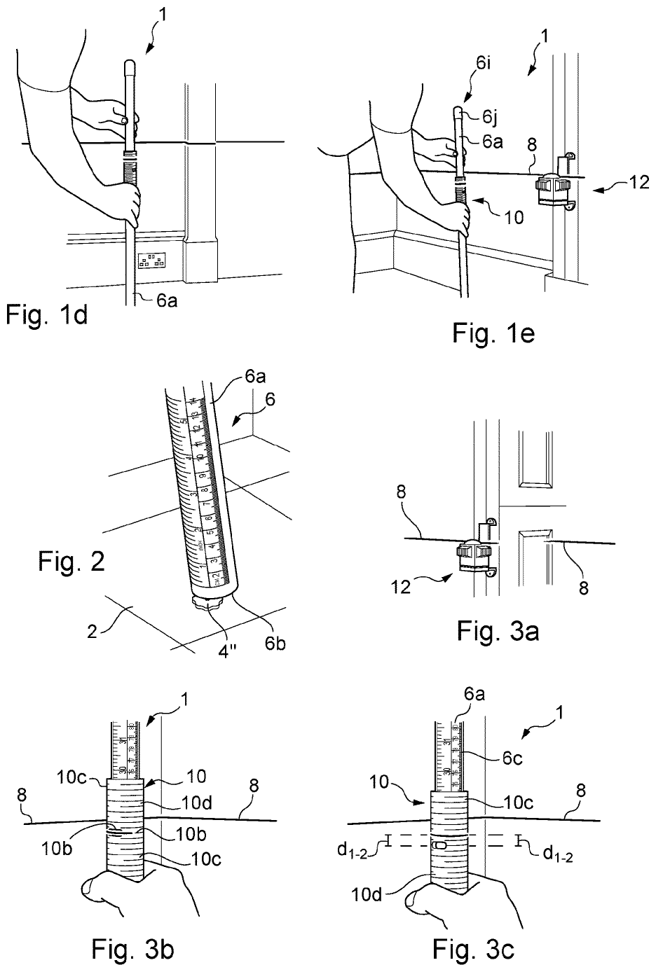

With reference to FIGS. 1a to 15, a levelling apparatus 1 for preparing a surface 2 to be levelled is shown.

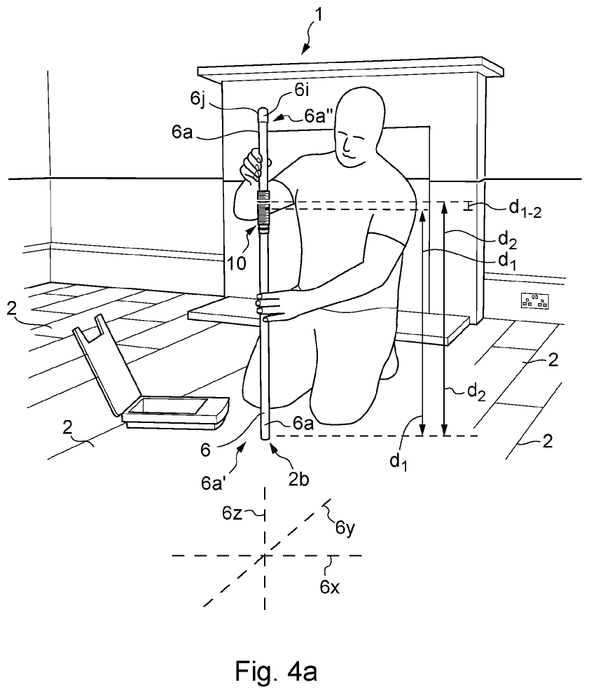

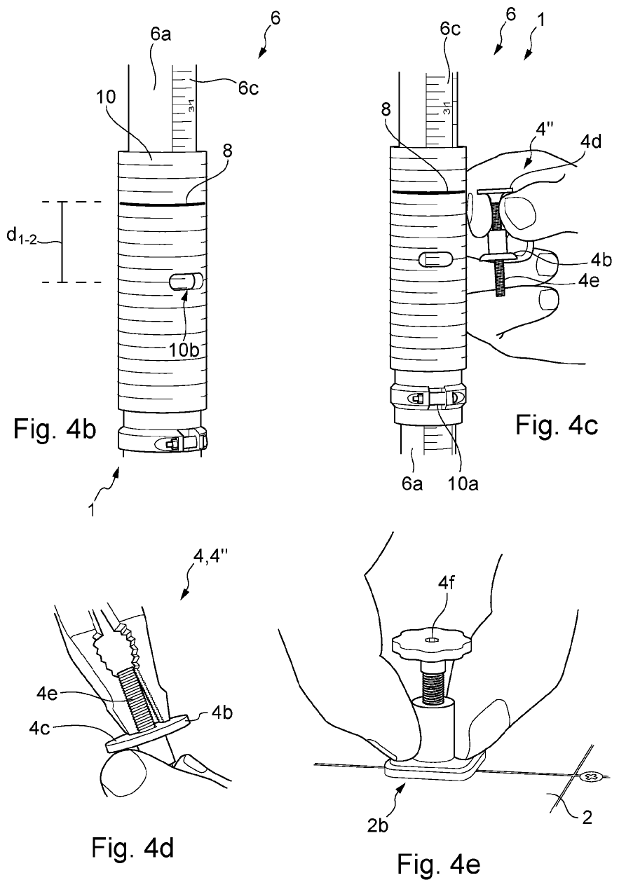

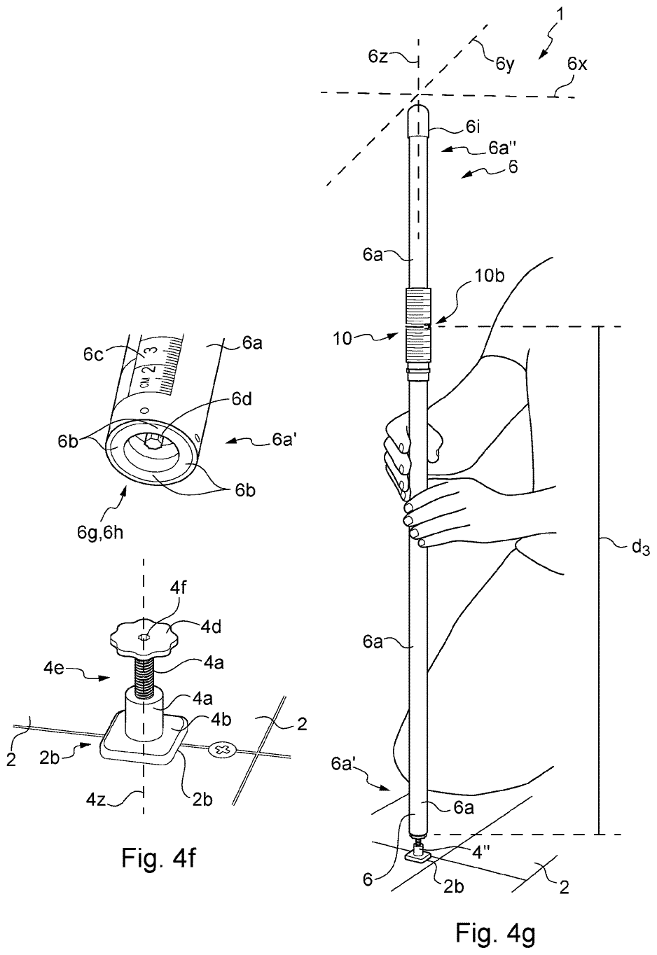

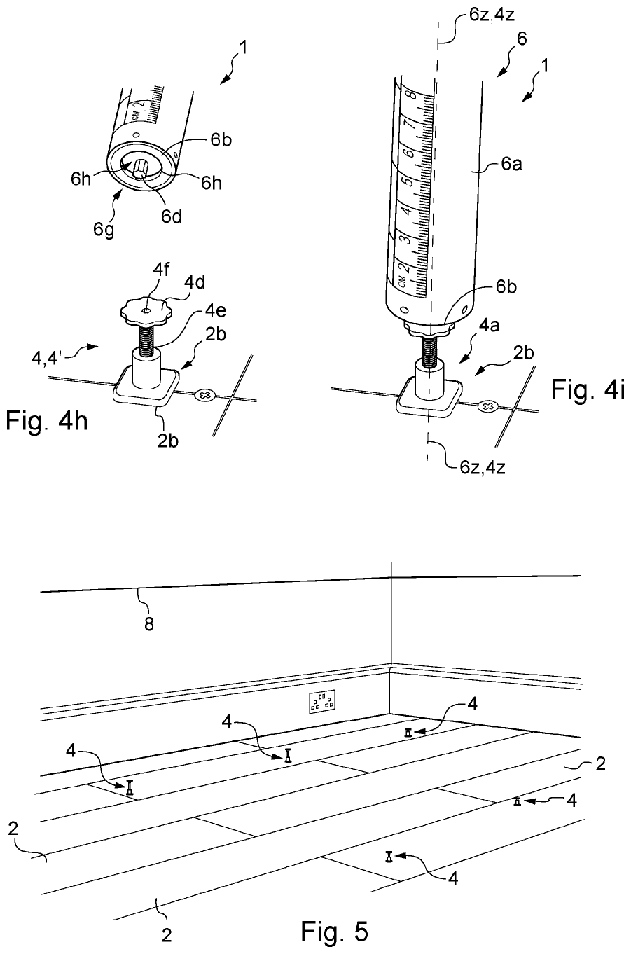

The levelling apparatus 1 comprises a measurement apparatus 6 comprising a body portion 6a, an engagement member 6b for engaging a surface 2, and the engagement member 6b is located at a first end 6a′ of the body portion 6a. The engagement member 6b is shown at FIG. 4f.

The measurement apparatus 6 is operable to measure:
a first distance d₁ (FIG. 1b) between a reference level 8 and a first point 2a of a surface 2 to be levelled; and
a second distance d₂ (FIG. 4a) between the reference level 8 and a second point 2b of the surface 2 to be levelled; and
the offset d₁₋₂ (FIG. 3c, FIG. 4a, FIG. 4b) between the first distance d₁ and the second distance d₂.

The levelling apparatus 1 comprises a plurality of levelling members 4 configured, in use when located on the surface 2, to reduce or eliminate the offset d₁₋₂ between the first distance d₁ and the second distance d₂.

Any number of levelling members 4 can be used, and it will be understood that in some examples only one levelling member 4 may be required.

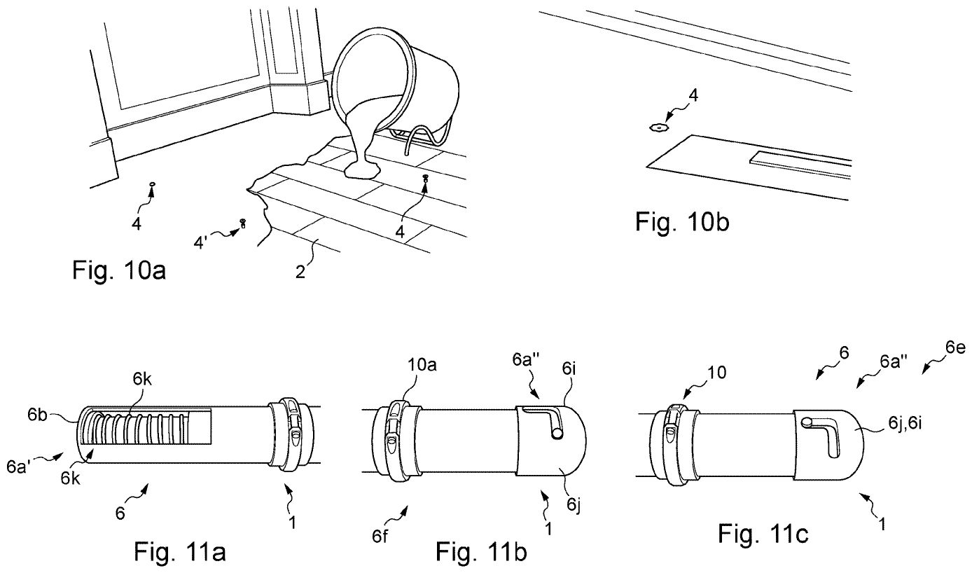

The levelling member 4 is for preparing the surface 2 to be levelled, and is a level indicator member for indicating a desired level of the surface 2 on which the levelling member 4 is located. An array of levelling members 4 secured to the surface 2 is shown at FIG. 5, with the levelling of the surface 2 shown at FIGS. 10a and 10b.

Each levelling member 4 acts as a spacer, bringing the existing level of the point of the surface 2 on which it is located up to a new, desired level. As will be described in more detail below, each levelling member 4 defines a desired level of that point of the surface 2, with the surface, or portion thereof, then levelled using a levelling agent (e.g., floor leveller or levelling screed, or the like) as is known in the art of surface levelling.

The measurement apparatus 6 and the levelling member 4 are separate, with the levelling members 4 intended to remain in situ once the surface 2 has been levelled.

In a typical application, the surface 2 to be levelled is either planar or non-planar, and is unlevel with respect to the reference level 8 (or at least a part of the surface 2 is unlevel). The surface 2 can include sloped portions, undulating portions, divots, bumps, or the like, and the embodiments of the invention are designed to be used to indicate a new desired level of the surface 2. Typically, the first point 2a (FIGS. 1a and 1b) and the second point 2b (FIG. 4a) of the surface 2 are each selected as substantially planar points of the surface 2, for locating the levelling members 4 thereon. It will be understood that the points on which the levelling member 4 are located need not be perfectly planar, and the skilled person when using the invention will be able to select the appropriate locations on the surface 2 for the levelling members 4 to be placed. This will include knowledge of the desired layout of the levelling members 4, which can be arranged in a grid.

It will be understood that, in use, further points of the surface 2 (third point, fourth point, etc) are used for locating levelling members 4 to build up indicators of the desired level of the floor, but for brevity here only bringing the second point 2b up to the desired level of the first point 2a is described, and it will be appreciated that each further point (third, fourth) is executed in the same way as the second point 2b, with the result being as shown at FIG. 5.

The first point 2a and the second point 2b can be of any desired dimensions, and can be points, regions, sections, lines, areas, or the like, on the surface 2, which will depend on many factors, such as the dimensions of the surface 2, the accuracy required for indicating the desired level, the planarity of the existing surface 2, etc. In the embodiments shown here, the first point 2a and the second point 2b are each on the order of less than 10 cm², determined by the size of the levelling member, but any suitable size of point can be used.

The surface 2 to be levelled may be a floor or portion thereof, a portion of the ground, a deck/decking or portion thereof, a foundation or portion thereof, or any suitable surface 2 to be levelled. Here, the invention is shown when used on an internal floor in a domestic dwelling.

With reference to FIG. 4a or 4g, the body portion 6a of the measurement apparatus 6 comprises a horizontal axis 6x, lateral axis 6y and a longitudinal axis 6z, which are orthogonal. The longitudinal axis 6z is arranged perpendicular to the surface 2 when the body portion 6a is engaged with the surface 2.

The measurement apparatus 6 includes measurement indicia 6c for indicating a distance from the surface 2, which can be used to indicate the first distance d₁, d₂, and the offset d₁₋₂. The measurement indicia 6c are located on an outer part of the body portion 6a and arranged along the longitudinal axis 6z. In the embodiments illustrated here, the measurement indicia 6c is a graduated scale, but a different measurement indicator or indicia could be used.

The body portion 6a of the measurement apparatus 6 is a cylindrical member and is elongate in the direction of the longitudinal axis 6z thereof. It will be appreciated that the body portion 6a could be another shape, such as a cuboid.

As shown in FIG. 4f, the engagement member 6b is substantially flat and configured for engaging a substantially planar portion of the first point 2a of the surface 2 and a planar portion of the second point 2b of the surface 2. It will be appreciated that the engagement member 6b can engage non-planar surfaces if required.

In the embodiments illustrated and described here the engagement member 6b is an abutment member configured to abut a planar portion of the surface 2 when engaged therewith.

The engagement member 6b is integral with the body portion 6a, and is a flat disc-shaped member. The engagement member 6b is circular, but other shapes are possible. The engagement member 6b is arranged orthogonal to the longitudinal axis 6z of the body portion 6a. The engagement member 6b is a planar member arranged on the horizontal-lateral plane of the body portion 6a.

As shown in FIGS. 4f and 4h, the engagement member 6b is defined by the end of the wall of the body portion 6a of the measurement apparatus 6, and the engagement member 6b defines a terminal end of the body portion 6a.

The engagement member 6b is configured to increase the stability of the body portion 6a in the direction of at least two axes of stability when the engagement member 6b is engaged with the surface 2. The axis of stability are the horizontal and lateral axes 6x, 6y. This is advantageous when using the measurement apparatus 6 to measure distances as it is thought to provide more stability than, for example, using a traditional rule. In the embodiments illustrated and described here, the engagement member 6b is formed from a single engagement member 6b, but in other embodiments could be formed from multiple engagement members.

As best shown in FIGS. 3b, 3c, 4b, and 4c, the measurement apparatus 6 comprises a reference marker 10 configured to indicate the position of the reference level 8 and operable, in use, to indicate the position of the reference level 8 on the body portion 6a of the measurement apparatus 6.

The reference marker 10 is separate to the body portion 6a, and the reference marker 10 is engageable with and connectable to the body portion 6a. The reference marker 10 is configured to be movable along the longitudinal axis 6z of the body portion 6a to indicate the position of the reference level 8. The reference marker 10 is movable relative to the engagement member 6b. The reference marker 10 is slidably engageable with the body portion 6a.

The reference marker 10 comprises a securing mechanism 10a (see FIG. 4c) for reversibly securing the reference marker 10 to the measurement apparatus 6. The securing mechanism 10a is a rotatable tab member. In other embodiments, the securing mechanism 10a could be part of the measurement apparatus 6.

The reference marker 10 includes a sleeve 10c, which fits over the body portion 6a. The reference marker 10 is a cylindrical member and has a complementary shape to the body portion 6a.

The reference marker 10 includes a reference indicator 10b for indicating the position of the reference level 8. The reference indicator 10b is a hole in the reference marker 10. Any suitable reference indicator 10b can be used. FIG. 3b shows when the reference indicator 10b is aligned with the reference level 8, and FIG. 3c shows when there is misalignment therebetween (FIGS. 4b and 4c also show misalignment due to the second point 2b of the surface 2 being below the first point 2a).

As perhaps best shown in FIGS. 4b and 4c, the reference marker 10 includes measurement indicia 10d for indicating a distance from the reference level 8. The measurement indicia 10d can indicate the first distance d₁, the second distance d₂, and the offset d₁₋₂. The measurement indicia 10d is a graduated scale, but other types of indicator or indicia can be used. The measurement indicia 10d are arranged above and below the position of the reference indicator 10b. The measurement indicia 10d are arranged, in use, along the longitudinal axis 6z of the body portion 6a of the measurement apparatus 6. The measurement indicia 10d of the reference marker 10 are arranged along the same direction as the measurement indicia 6c of the measurement apparatus 6. It will be understood that measurement indicia can be arranged on the measurement apparatus 6, the reference indicator 10, or combination thereof.

With reference to FIG. 4a, the measurement apparatus 10 is configured to measure straight distances along the longitudinal axis 6z of the body portion 6a, with the first distance d₁, the second distance d₂ and the offset d₁₋₂ all being straight distances measured along the longitudinal axis 6z of the body portion 6a.

Present at FIG. 1e, the levelling apparatus 1 comprises a reference level device 12 operable to provide the reference level 8, which in this embodiment is an optical reference level 8. The reference level device 12 is a laser spirit level device configured to be mountable on a support structure, such as a wall, as is known in the field of optical level devices. It will be appreciated that other types of reference level device 12 can be used with the present invention, and it is not essential that an optical device is used.

The reference level device 12 is operable to provide a plane laser reference level 8 along a horizontal plane. In other embodiments it may be sufficient to use a line reference level along an axis.

The reference level 8 is spaced vertically from the surface 2. The reference level 8 is a horizontal level, which is typically a substantially true horizontal level. The longitudinal axis 6z of the body portion 6a is arranged, in use to be substantially perpendicular to the reference level 8 when engaged with the surface 2.

The longitudinal axis 6z of the body portion 6a is arranged substantially vertically when the body portion 6a is engaged with the surface 2, as shown in FIG. 4a. The longitudinal axis 6z of the body portion 6a is normal to the surface 2 when engaged therewith.

The reference level 8 is on a horizontal plane perpendicular to the longitudinal axis 6z of the body portion 6a in use. The reference level device 12 is operable to illuminate the reference level 8 on the measurement apparatus 6, which can be seen as a streak of laser light thereon in FIGS. 1b, 1c, 1d, 1e, 3b, 3c, 4a, 4b, 4c, and 4g.

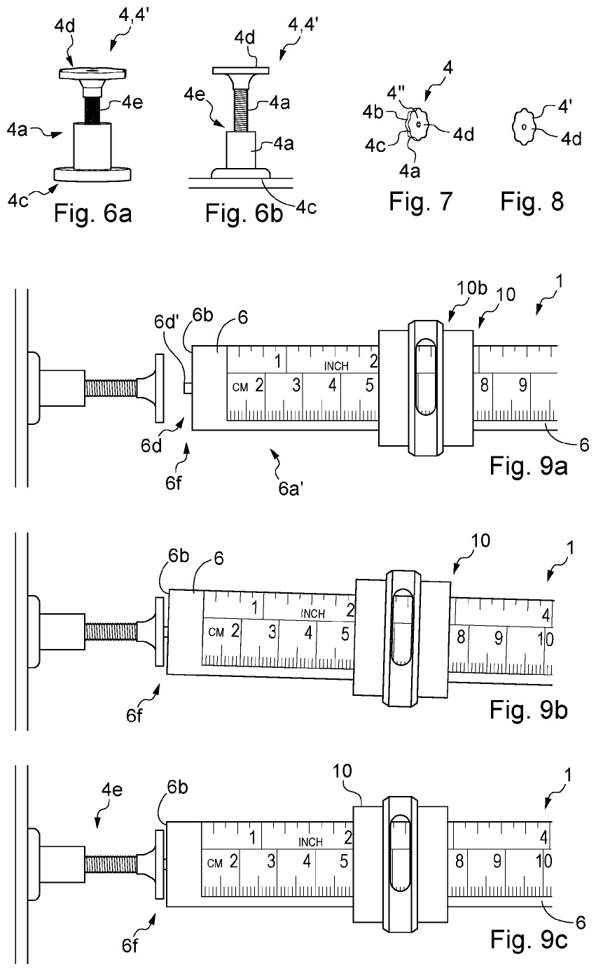

With reference to FIGS. 4f, 4h, 6a and 6b the levelling member 4 comprises a body portion 4a, and a planar base 4b for engaging with the surface 2 to be levelled. The base 4b is securable to the surface 2 by a securing member 4c. In some embodiments, the securing member 4c is an adhesive, and in other embodiments a surface penetrating member, such as a spike member, or the like. The adhesive version is typically used for hard surfaces, with the spike version used on soil, for example for levelling prior to installing a deck.

The levelling member 4 comprises a planar level indicator 4d configured to indicate a desired level of the surface 2.

The levelling member 4 is configured to remain secured to the surface 2, in use, when the levelling agent is applied to the surface 2 and when the levelling agent has set.

The base 4b and the level indicator 4d of the levelling member 4 are located at opposing ends of the body portion 4a thereof.

The levelling apparatus 1 comprises one or more first levelling members 4′ (FIGS. 6a and 6b) and one or more second levelling members 4″ (FIGS. 2 and 7). The first levelling member(s) 4′ are height adjustable whereas the second levelling member(s) 4″ have a fixed height.

The second levelling member 4″ is a rigid shim, or block, as are common for use as spacers.

The first levelling member 4′ is configured to be adjustable between a first height and a second height. At the second height, the distance between the level indicator 4d and the base 4b is greater than at the first height.

FIGS. 6a and 6b demonstrate different heights, with FIGS. 9a to 9c showing in detail the process of adjusting the height.

The body portion 4a of each levelling member 4 comprises a longitudinal axis 4z. The first levelling member 4′ is height adjustable along the longitudinal axis 4z of the body portion 4a thereof. FIG. 4i shows how the longitudinal axes 4z, 6z of the levelling member 4 and measurement apparatus 6 align when the components are engaged with each other.

The first levelling member 4′ comprises an adjustment mechanism 4e for adjusting the height thereof. The adjustment mechanism 4e is configured to adjust the spacing between the level indicator 4d and the base 4b. The adjustment mechanism 4e includes a screw thread for converting rotational movement of the level indicator 4d relative to the base 4b into translational movement of the level indicator 4d relative to the base 4b.

Each levelling member 4 is configured to be stackable on at least one other levelling member 4. The base 4b of each levelling member 4 is stackable on the level indicator 4d of another levelling member 4 and the level indicator 4d of each levelling member 4 is stackable with the base 4b of the other levelling member 4.

The first levelling member 4′ is stackable on the second levelling member 4″ and the second levelling member 4″ is stackable on the first levelling member 4′.

The levelling apparatus 1 comprises any suitable number of stackable levelling members 4.

The stacking of the levelling members 4 is along the longitudinal axis 4z of the body portion 4a of each levelling member 4.

As shown in FIG. 4g, the measurement apparatus 6 is operable to measure a third distance d₃ between the levelling member 4 and the reference level 8. The third distance d₃ is measured when the levelling member 4 is located on the surface 2 and is measured from the level indicator 4d to the reference level 8. The measurement apparatus 6 is operable to measure the offset d₁₋₃ between the third distance d₃ and the first distance d₁ and the offset d₂₋₃ between the third distance d₃ and the second distance d₂. The third distance d₃ is a straight distance along the longitudinal axis 6z of the body portion 6a of the measurement apparatus 6.

The engagement member 6b of the measurement apparatus 6 is configured for abutment, in use, with the levelling member 4, which is shown in FIG. 2 or FIG. 4g. The measurement apparatus 6 is operable to measure the third distance d₃ when the engagement member 6b is in abutment with the levelling member 4.

The measurement apparatus 6 is operable to adjust the height of the first levelling member 4′. The measurement apparatus 6 is configurable to be engageable with the first levelling member 4′. The measurement apparatus 6 is configured to be temporarily securable to the first levelling member 4′ when engaged therewith.

The measurement apparatus 6 is operable, in use, to engage with and adjust the adjustment mechanism 4e of the levelling member 4 to adjust the height of the first levelling member 4′ between the first height and the second height.

The measurement apparatus 6 is operable, in use, to apply a torque to the adjustment mechanism 4e of the first levelling member 4′. Applying a torque may be carried out, in use, by rotating the measurement apparatus 6 about an axis of rotation (the longitudinal axis 6z) when the measurement apparatus 6 is engaged with the first levelling member 4′. Applying a torque is carried out when the first levelling member 4′ is secured to the surface 2, which holds the base 4b fixed so that the level indicator 4d can be rotated relative thereto. The adjustment mechanism 4e is configured such that the application of a torque thereto adjusts the height of the first levelling member 4′. It will be appreciated that the levelling member 4 could be designed to be height adjustable in other ways.

The height of the first levelling member 4′ is adjustable up or down, such that the height can be increased or decreased.

The measurement apparatus 6 is configured to be releaseably engageable with the first levelling member 4′.

As best shown in FIG. 4h, the measurement apparatus 6 comprises an adjustment element 6d for operating the adjustment mechanism 4e. The adjustment element 6d is configured to operate the adjustment mechanism 4e by engaging with and applying a torque thereto.

The adjustment element 6d is located at the first end 6a′ of the body portion 6a of the measurement apparatus 6, which is the same end as the engagement member 6b. The adjustment element 6d is located adjacent to the engagement member 6b.

The adjustment element 6d includes a protrusion 6d′ for engaging with the first levelling member 4′. The first levelling member 4′ includes a corresponding protrusion receiving portion 4f.

The measurement apparatus 6 is operable to configure the adjustment element 6d between a withdrawn state 6e (FIG. 4f) and a deployed state 6f (FIG. 4h). In the withdrawn state 6e, the adjustment element 6d is contained within the body portion 6a of the measurement apparatus 6. In the withdrawn state 6e, the adjustment element 6d is arranged to be level with or a distance behind the engagement member 6b of the measurement apparatus 6. In the deployed state 6f, the adjustment element 6d is arranged to protrude from the body portion 6a of the measurement apparatus 6. In the deployed state 6f, the adjustment element 6d is arranged to protrude beyond the engagement member 6b of the body portion 6a of the measurement apparatus 6.

The adjustment element 6d is configured to protrude in the direction of the longitudinal axis 6z of the body portion 6a of the measurement apparatus 6.

In the deployed state 6f, the protrusion 6d′ of the adjustment element 6d is configured to protrude beyond the body portion 6a of the measurement apparatus 6.

The body portion 6a includes a cavity 6g for housing the adjustment element 6d. The body portion 6a includes an opening 6h to the cavity 6g at the first end 6a'. The engagement member 6b defines the opening 6h to the cavity 6g.

The cavity 6g is defined by a hollow part of the body portion 6a.

The measurement apparatus 6 is operable to measure the third distance d₃ when the adjustment element 6d is engaged with the first levelling member 4′. The measurement apparatus 6 is operable to measure the third distance d₃ when the adjustment element 6d is in the deployed state 6f.

The measurement apparatus 6 comprises a hand-operable, manual control 6i operable to configure the adjustment element 6d between the withdrawn state 6e and the deployed state 6f. The control 6i is operable to fix the adjustment element 6d in the withdrawn state 6e and to fix the adjustment element 6d in the deployed state 6f. The control 6i includes an operating element 6j located at a second end 6a″ of the body portion 6a of the measurement apparatus 6. The operating element 6j is located at the opposite end of the body portion 6a to the engagement member 6b. The operating element 6j includes a grip member and is partially rotatable about the longitudinal axis 6z of the body portion 6a for configuring between the withdrawn state 6e and the deployed state 6f. The positions of the operating element 6j are best shown in FIGS. 11b and 11c.

The control 6i includes a biasing element 6k configured to assist in the movement of the adjustment element 6d from the deployed state 6e to the withdrawn state 6e. The biasing element 6k includes a compression spring located within the body portion 6a. The biasing element 6k is configured to bias the adjustment element 6d towards the withdrawn state 6e. All of the embodiments illustrated in FIGS. 1a to 11c have the biasing element 6k, but FIG. 11a is designed to show its arrangement. It will be understood that any particular method of moving the adjustment element 6d can be used.

The adjustment mechanism 4e of the first levelling member 4′ includes an adjustment member (fulfilled by the protrusion receiving portion 4f) for operating the adjustment mechanism 4e. The adjustment element 6d of the measurement apparatus 6 is configured to be engageable with the protrusion receiving portion 4f of the first levelling member 4′. The protrusion receiving portion 4f is a screw drive member, but other options are possible.

The adjustment mechanism 4e of the first levelling member 4 is a manual adjustment mechanism 4e operable by hand or by the measurement apparatus 6.

FIGS. 9a to 9c show another embodiment of the measurement apparatus 6 of FIGS. 1a to 4i, with the main differences being the body portion 6a has a greater diameter, a shorter length, and the reference marker 10 is truncated with no measurement indicia 10d present.

FIGS. 11a to 11c show the embodiment of the measurement apparatus 6 of FIGS. 9a to 9c with a cut-away portion showing the location of the biasing element 6k within the cavity 6g of the body portion 6a. FIGS. 11b and 11c show two end positions of the operating element 6j, with FIG. 11b showing the deployed state 6f and FIG. 11c showing the withdrawn state 6e.

An example of how the invention can be used will now be provided.

First, for a surface 2 to be levelled, a reference level 8 is provided by the reference level device 12.

Next, as shown in FIGS. 1a and 1b, a first point 2a of the surface 2 is selected and the measurement apparatus 6 is brought into engagement with the first point 2a, by abutting the engagement member 6b against the first point 2a. This will typically be the highest point of the surface 2, although it can simply be chosen to be approximately the highest point of the surface 2. It is not essential to use the highest point.

Typically, the step of engaging the measurement apparatus 6 with the first point 2a will be done without adding a levelling member 4 to the first point 2a. However, the level of the first point 2a can easily be brought upwards by adding a second levelling member 4″, as shown in FIG. 2, so that when the surface 2 is to be levelled, the first point 2a is also raised up to a new level.

Next, as shown in FIG. 1b, the reference marker 10 is slid along the body portion 6a in order to align the reference indicator 10b with the reference level 8, whilst the measurement apparatus 6 is in abutment with the first point 2a. FIG. 3c shows the reference indicator 10b in such a position. It will be understood that if a levelling member 4 is used for the first point 2a, the reference marker 10 will be brought into alignment when the measurement apparatus 6 is in abutment with the levelling member 4 at the first point 2a.

Whilst abutting the first point 2a, the measurement apparatus 6 can be used to measure a first distance between the reference level 8 and the first point 2a of the surface 2. This first distance is shown at FIG. 1b. The position of the reference indicator 10b marks this first distance d₁.

Next, as shown in FIG. 4a, the measurement apparatus 6 is brought into abutment with a second point 2b of the surface 2. In this position, the reference indicator 10b still shows the first distance d₁ mark, and the reference level 8 is now offset from the reference indicator 10b (see FIGS. 4a and 4b), as the second point 2b is below the first point 2a. The position of the reference level 8 on the measurement indicia 10d shown in FIG. 4b highlights the second distance d₂ between the reference level 8 and the second point 2b of the surface 2 to be levelled. FIG. 4a shows the second distance d₂ in full. Thus, as shown in FIG. 4b, the offset d₁₋₂ between the first distance d₁ and the second distance d₂ can be measured as the distance between the reference level 8 (visible on the reference marker) and the reference indicator 10b. Using this measurement, a levelling member 4 can be selected from a kit of levelling members 4 matching the offset d₁₋₂, or if no match is available, a first levelling member 4′ that is adjustable in height can be used and adjusted as shown in FIG. 4c to match the offset.

When adjusting the first levelling member 4′, it may be that part of the adjustment mechanism 4e protrudes under the base 4b. As shown in FIG. 4d, this part of the adjustment mechanism 4e can be snapped off using pliers, before the levelling member 4 is then secured to the second point 2b of the surface using an adhesive. The levelling members 4 come with an adhesive, but it will be understood that the adhesive could be applied when securing the levelling members 4 to the surface 2.

As shown in FIG. 4g, the levelling member 4, when secured to the surface 2, is configured to reduce or eliminate the offset d₁₋₂, as it can be seen in FIG. 4g that the reference level 8 now lines up with the reference indicator 10b.

If any fine adjustment of the first levelling member 4′ is required, then the adjustment element 6d of the measurement apparatus 6 is brought near the levelling member 4′ and transitioned from the withdrawn state 6e (FIG. 4f) to the deployed state 6f (FIG. 4h), and the protrusion 6d′ is then brought into engagement with the protrusion receiving portion 4f of the levelling member 4′ (FIG. 4i) and the height of the first levelling member 4′ adjusted until the reference level 8 is in line with the reference indicator 10b. It will be appreciated that when the situation shown in FIG. 4i occurs, the measurement apparatus 6 measures a third distance d₃ from the levelling member 4 to the reference level 8.

Next, the user typically selects multiple locations for levelling members 4, as shown in FIG. 5, where the process of working with the second point 2b outlined above is repeated for each new point on the surface 2, to build up the desired array of levelling members 4. It will be understood that, depending on the nature of the area to be levelled, one or more levelling members 4 may be required (i.e. it is not essential to build up an array).

Once the levelling members 4 are arrayed on the surface 2, as shown in FIG. 10a a levelling agent is applied to the surface 2 until the levelling agent sits in line with each levelling member 4, as shown in FIG. 10b and FIG. 8. In this way, the true level of the surface 2 is achieved.

It will be appreciated that when using the method, a combination of first and second levelling members 4′, 4″ can be stacked to make a levelling member of suitable dimensions to reduce the offset between the second point 2b and the first point 2a.

One of the main advantages of this invention is that the true level of a surface 2 to be levelled can be obtained in an efficient manner, prior to then levelling the surface 2.

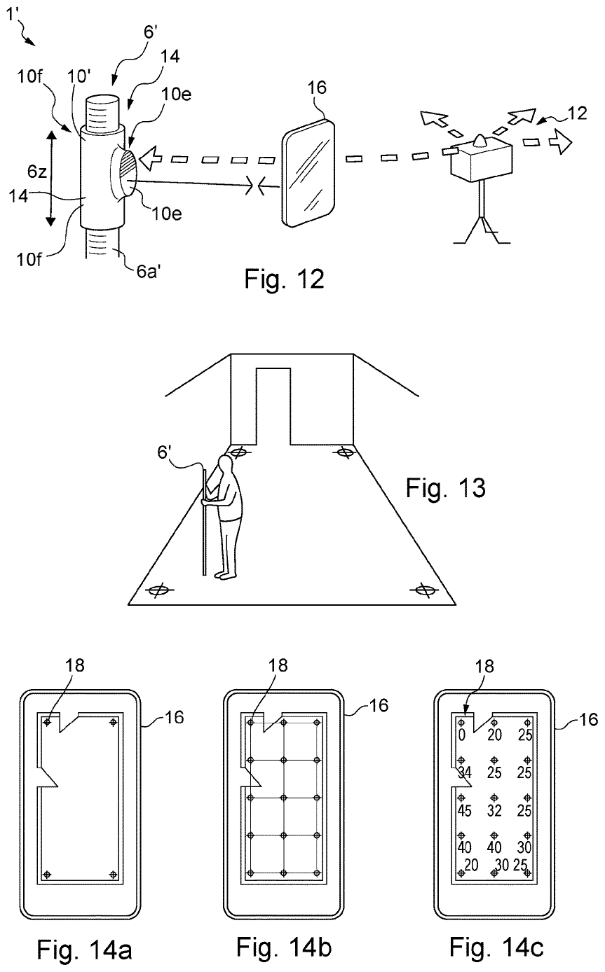

An alternative embodiment is shown in FIGS. 12 to 15, in which the levelling apparatus 1′ includes substantially the same features as the levelling apparatus of FIGS. 1a to 11c, with the addition of some electronic and optical components, as well as other features, which will be described in more detail below, followed by examples of use thereof. Like reference signs have been used with the suffix ′ for the features of the alternative embodiment.

The measurement apparatus 6′ is operable to detect the first distance d₁ the second distance d₂, and the third distance d₃.

The reference marker 10′ comprises an optical reference detector 10e configured to detect the reference level 8. The reference detector 10e is a laser light detector, and suitable options are the Spectra Precision (RTM) HR 300 laser receiver or the Fukuda FRD-300R-205 laser receiver, although many options are available for this component.

The reference detector 10e is fixed to the reference marker 10′ and is separate to and slidably engageable with the body portion 6a′ of the measurement apparatus 6′. The reference detector 10e is configured to be movable along the longitudinal axis 6z of the body portion 6a′ to detect the position of the reference level 8. The reference detector 10e is movable relative to the engagement member 6b.

The reference marker 10′ comprises a distance detector 10f configured to measure the first distance d₁ the second distance d₂, and the third distance d₃. In the embodiment shown in FIGS. 12 to 15, the distance detector is a single, electronic height detector. This may function through an electronic contact on the body portion 6a′ to determine how far up the distance detector 10f is, but other height/distance detectors 10f can be used.

The distance detector 10f moves with the reference marker 10′. The distance detector 10f is at least a part of the reference marker 10′, and is fixed thereto. At least a part of the distance detector 10f (excluding the electronic contact) is separate to the body portion 6a′. At least a part of the distance detector 10f is slidably engageable with and connectable to the body portion 6a′. The distance detector 10f is configured to be movable along the longitudinal axis 6z of the body portion 6a′ to detect the first distance d₁ the second distance d₂, and the third distance d₃. The distance detector 10f is movable relative to the engagement member 6b. The measurement apparatus 6′ is operable to detect the first distance d₁ the second distance d₂, and the third distance d₃ using data from the reference detector 10e and data from the distance detector 10f.

The measurement apparatus 6′ comprises a processor (not shown) operable to calculate the offset d₁₋₂ between the detected first distance d₁ and the detected second distance d₂. The processor is operable to calculate the offset between the third distance d₃ and the first distance d₁ and the offset between the third distance d₃ and the second distance d₂. The processor can be any suitable processor, such as an embedded controller, a microcontroller-based system, or the like.

The measurement apparatus 6′ comprises a communication element 14 within the reference marker 10 and operable to transmit the detected first distance d₁, the detected second distance d₂, the calculated offset d₁₋₂ therebetween, the third distance d₃, the offset between the third distance d₃ and the first distance d₁ and the offset between the third distance d₃ and the second distance d₂, to a user device 16.

The user device 16 is a smartphone, but any suitable computing device could be used, such as a laptop, a PC, a tablet, or the like.

The communication element 14 is configured for wireless communication with the user device 16 by Bluetooth® and can be paired with the user device 16. Any suitable Bluetooth® or other wireless communication protocol, such as Wifi® can be used as required.

The communication element 14 is operable to communicate wirelessly via Bluetooth with the reference level device 12. However, in other embodiments a different wireless communication protocol, such as Wifi® or the like, could be used.

The measurement apparatus 6′ comprises a positioning system configured to infer the position of the measurement apparatus 6′ relative to the reference level device 12. The inferred position is the offset in the horizontal plane. The inferred position is accurate to about 200 mm or less, but other suitable accuracies could be used. The purpose of this offset data being gathered is that the positioning system uses received signal data by the communication element 14 from the reference level device 12 to, at least in part, infer the position of the measurement apparatus, which can be used to build up a grid of coordinates (a floor plan) for levelling.

The measurement apparatus 6′ is operable to transmit the inferred position to the user device 16. The measurement apparatus 6′ and/or the user device 16 is configured to associate distance values, and offset values, with each inferred position to build an array of coordinates of measurements.

The user device 16 is operable to record an initial point 18 of the surface 2 to be levelled, which may be substantially the highest point of the surface 2 to be levelled.

The user device 16 is operable to generate a template set of points to be levelled. The template may include the initial point 18, and one or more further points to be levelled. The template may be a grid. The user device 16 includes user input field(s) to determine the template. The user device 16 is operable to determine when the inferred position of the measurement apparatus 6′ is sufficiently close (e.g. within a pre-set tolerance) to the point of the template.

The user device 16 comprises three levelling modes, but in other embodiments, could comprise one or more levelling modes.

In a first levelling mode, the user device 16 is operable to receive measurements from the measurement apparatus 6′, and to record one or more distances and/or offsets for each coordinate point on the surface to 2 be levelled.

In a second levelling mode, the user device 16 is operable to determine the offset between each second distance and the first distance. The user device 16 can record each desired offset for each coordinate of the surface 2 to be levelled. The user device 16 is operable to receive input from the user to determine, at least in part, the desired offsets. The second operating mode is configured to allow one or more gradients to be input to the user device 16. The, or each gradient is measured along a horizontal direction. In some examples, the, or each gradient is measured from the initial point 18 of the surface to be levelled. The one or more gradients may be negative (sloping downwards), positive (sloping upwards), or combination thereof. The one or more gradients may be substantially linear (e.g. 1:80, or the like).

The measurement apparatus 6′ is operable to communicate with a further measurement apparatus 6″.

The further measurement apparatus 6″ comprise the same features and functionality of the measurement apparatus 6′ as described herein. It will be appreciated that in other embodiments, there may be some differences between the measurement apparatus 6′ and the further measurement apparatus 6″.

The communication element 14 of the measurement apparatus 6′ is operable to communicate with the further measurement apparatus 6″ to transmit and/or receive distance data and/or offset data, to/from the further measurement apparatus 6″, optionally the initial point 18 of the surface to be levelled. This is advantageous when using multiple measurement apparatus 6′, 6″ to measure more than one room or area.

The levelling apparatus 1′ may comprise a plurality of further measurement apparatus 6″.

The further measurement apparatus 6″ is operable to transmit detected distance(s)/offsets from the further measurement apparatus 6″ to the user device 16.

The measurement apparatus 6′ is operable to transmit distance/offset data, received from the further measurement apparatus 6″, to the user device 16. The further measurement apparatus 6″ is operable to transmit distance/offset data, received from the measurement apparatus 6′, to the user device 16.

In a third levelling mode, the user device 16 is operable to apply a global offset to the coordinates of points of the surface 2 to be levelled. The user device 16 is operable to apply a local offset to one or more of the coordinates of points based, at least in part, on a threshold level.

The user device 16 is operable to calculate the volume of levelling agent, or volume of levelling agents (e.g. floor leveller or levelling screed) required. The user device 16 is operable to display the calculated volume of levelling agent, or levelling agents.

The user device 16 is operable to receive user input on the type of surface 2 to be levelled. This may include a list of one or more substrates, such as timber, concrete, ceramic, stone, underfloor wet or electric heating, or the like. The type of substrate may be the bulk substrate and/or the surface finish thereof.

The user device 16 is operable to receive user input on the humidity.

The user device 16 is operable to display one or more suitable types of levelling agent, which in some examples may include item(s) orderable from one or more suppliers. The user device 16 is operable to permit the user to purchase or order one or more of the displayed suitable levelling agents.

The user device 16 is operable to run application software configured, when run, to carry out one or more of the functions of the user device 16 as described herein.

An example of how the alternative embodiment of FIGS. 12 to 15 may be used will now be provided.

First, the reference level device 12 is setup in the usual manner, to provide the reference level 8, at a suitable height.

Next, as shown in FIG. 13, the measurement apparatus 6′ is used to get inferred positions (here shown as the four corners of the room), and these inferred positions are communicated by Bluetooth (RTM) to the user device 16, and as shown in FIG. 14a, the four corners are shown in the application software of the user device 16. It will be understood that the boundary and doors of the room can be set up by entering such information into the user device 16, and for brevity a discussion on this part of the user device 16 functionality will be omitted.

Next, the user enters the desired grid properties on the user device 16, such as 1 metre×1 metre, and the user device will generate a grid of coordinates. These coordinates represent points on the surface 2 where measurements will be taken, to determine the offsets.

Next, the user device 16 will prompt the user to select from a number of modes. For example:
a) Do you want to level?
b) Do you want to level and sweeten (to thresholds, etc)?
c) Do you want to form a gradient plane.

Sweetening generally refers to, once a set of coordinates has been built up, locally offsetting the coordinates, or applying a global offset, to even out errors in measurements.

Dealing with mode a), the next step is to find the highest point in the room, the initial point 18, and to measure the first distance d₁ at this point. This initial point will of course have no offset, and will show as “0” on the user device 16 at top left of FIG. 14c.

Next, using the measurement apparatus 6′ and the positioning apparatus thereof, the user locates the measurement apparatus 6′ at each point to be measured, by communicating with the reference level device 12 via Bluetooth (RTM) and communicating this to the user device 16, which will show when the measurement apparatus 6′ is at, or near to the coordinate point (within the tolerance value). It is not important to be precise with the horizontal position here, but the accuracy of the vertical distance is what is important. Here, once at the desired point, the offset d₁₋₂ is determined by transmitting the second distance value d2 to the user device 16. It is not important whether the user device calculates the offset d₁₋₂ or if the processor of the measurement apparatus 6′ does this. The user device 16 displays the offset between the initial point 18 and each coordinate point, as shown in FIG. 14c. This is done each time by adjusting the reference detector 10e to align with the reference level 8, which at the same time adjusts the distance detector 10f. In some embodiments, it may be that the user “confirms” the measurement to send it to the user device 16, or there may be other means of doing this, such as by confirming on the user device 16 that the measurement is to be stored/displayed.

As per the embodiment of FIGS. 1 to 11c, the levelling member 4 at each coordinate is adjusted in the usual manner.

Next, in mode a), and once all coordinate points have been measured, the user device 16 can calculate the volume of levelling agent required. Should it be desirable, before obtaining a final volume, the user could apply a global offset (e.g. by a few millimetres or so) to ensure that the level of the surface 2 will be brought up to a desired value. Similarly, one or more local offsets could be applied according to the skilled practitioner's knowledge (e.g. if they know a small section of surface has special circumstances associated with it.)

The user device 16 will also at this stage ask the user for input on the type or finish of the surface 2, and the moisture content (humidity), to then suggest a suitable levelling agent and in some examples this may include the option to source the levelling agent from a supplier.

In mode b), a threshold value (e.g. 5 millimetres) may be added to the initial value 18, and the user device 16 will then automatically adjust all other values if necessary to provide a closest-to-level finish.

It will be understood that when an offset is applied, such as in mode b), the user can then adjust the height of each levelling member 4 accordingly, to ensure the levelling agent comes up to the correct height. In mode c), gradients, a starting gradient requirement can be entered into the user device 16. The gradient can be linear, for example 1:80 in one horizontal direction. The user will enter this, and the app will automatically determine the required offsets for the coordinate points. The user then just needs to adjust the levelling members 4 to the height to then use the levelling agent to create the gradient on the surface 2.

The gradient can run in more than one direction, e.g. when paving a corner that slopes in more than one direction.

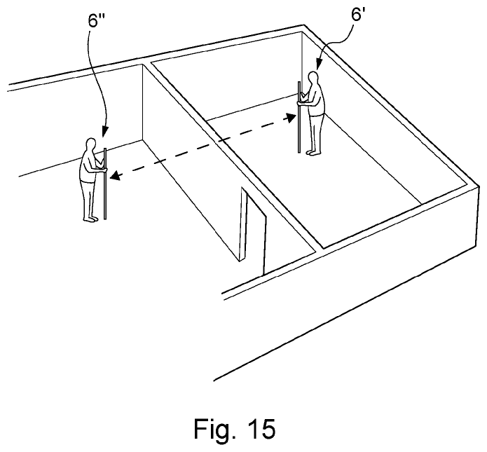

In some examples, the next stage can be to continue working in a second room, or space. Taking the example of an adjacent room, as shown in FIG. 15, one measurement apparatus 6′ can be used to communicate the initial point 18 to the other measurement apparatus 6″ and/or to the user device 16, and in this way the coordinate of points can include both rooms, and any number of further spaces, with the user device 16 then having the complete coordinate set for levelling.

Modifications and improvements may be made to the foregoing embodiments without departing from the scope of the present invention.

For example, the measurement apparatus 6 could comprise a single reference marker 10 or a plurality of reference markers 10.

Although only one continuous engagement member 2b has been shown, there could be a number of engagement members 2b, which can be designed to have any suitable properties for engaging the surface 2.

It will be understood that although a laser reference level, setting out a reference plane, has been shown, other references, such as a plumb line, could be employed instead of, or in addition to, an optical-based reference level device 12.

The engagement member 2b need not be integral with the body portion 6a.

1. A levelling apparatus for preparing a surface to be levelled, the apparatus comprising:
a levelling member;
a measurement apparatus comprising:
a body portion; and
an engagement member for engaging a surface, the engagement member located at an end of the body portion;
wherein the measurement apparatus is operable to measure:
a first distance between a reference level and a first point of a surface to be levelled;
a second distance between the reference level and a second point of the surface to be levelled; and
an offset between the first distance and the second distance;
wherein the levelling member is configured, in use when located on the surface, to reduce or eliminate the offset between the first and second distances.

2. The levelling apparatus of claim 1, wherein the surface to be levelled is a floor or portion thereof, or a portion of the ground, or a deck/decking or portion thereof, or a foundation or portion thereof.

3. The levelling apparatus of claim 1, wherein the engagement member is:
substantially flat; and/or
configured to increase the stability of the body portion in the direction of at least one axis of stability, optionally at least two axes of stability when the engagement member is engaged with the surface.

4. (canceled)

5. The levelling apparatus of claim 1, wherein the measurement apparatus comprises a reference marker operable in use, to indicate the position of the reference level on the measurement apparatus, or on the body portion thereof.

6. The levelling apparatus of claim 5, wherein at least one of:
the reference marker is configured to be movable along the body portion to indicate the position of the reference level;
the measurement apparatus and/or the reference marker are configured to indicate the first distance and/or the second distance, wherein the measurement apparatus and/or the reference marker are configured to indicate the offset between the first distance and the second distance; and
the measurement apparatus and/or the reference marker include a measurement indicator or indicia for indicating distance or distances from the reference level.

9. The levelling apparatus of claim 1, wherein the reference level is an optical reference level.

10. The levelling apparatus of claim 1, wherein the levelling member comprises:
a body portion;
a base for engaging with the surface to be levelled; and
a level indicator configured to indicate a desired level of the surface; and
wherein the base and the level indicator are located at opposing ends of the body portion.

11. The levelling apparatus of claim 1, wherein the levelling member comprises an adjustment mechanism for adjusting the height thereof.

12. The levelling apparatus of claim 1, wherein the measurement apparatus is operable to measure a third distance between the levelling member and the reference level, and to measure an offset between the third distance and the first distance and/or an offset between the third distance and the second distance.

13. The levelling apparatus of claim 1, wherein the measurement apparatus is engageable with the levelling member and the measurement apparatus is operable to adjust a height of the levelling member.

14-15. (canceled)

16. The levelling apparatus of claim 13, wherein the measurement apparatus comprises an adjustment element for operating the adjustment mechanism of the levelling member; optionally wherein the adjustment element of the measurement apparatus is located at the same end of the body portion as the engagement member.

17. (canceled)

18. The levelling apparatus of claim 16, wherein the measurement apparatus is operable to configure the adjustment element between a withdrawn state and a deployed state; optionally wherein the measurement apparatus comprises a control operable to configure the adjustment element between the withdrawn stale and the deployed stale.

19. The levelling apparatus of claim 18, wherein, in the withdrawn state, the adjustment element is arranged to be level with or a distance behind the engagement member of the measurement apparatus, and wherein, in the deployed state, the adjustment element is arranged to protrude from the body portion of the measurement apparatus.

20. The levelling apparatus of claim 16, wherein the measurement apparatus is operable to measure a third distance when the adjustment element is engaged with the levelling member.

21. (canceled)

22. The levelling apparatus of claim 1, wherein the measurement apparatus is operable to detect the first distance and/or the second distance.

23. (canceled)

24. The levelling apparatus of claim 22, wherein the measurement apparatus comprises a distance detector configured to measure the first distance and/or the second distance; optionally wherein:
the measurement apparatus is operable to detect the first distance and/or the second distance using data from the reference detector and/or data from the distance delector.

25. (canceled)

26. The levelling apparatus of claim 22, wherein the measurement apparatus comprises a communication element operable to transmit the detected first distance, the detected second distance, and/or the offset therebetween, to a user device.

27. The levelling apparatus of claim 1, wherein the measurement apparatus comprises a positioning system configured to infer the position of the measurement apparatus relative to a reference level device; optionally wherein.
the measurement apparatus is operable to transmit the inferred position to the user device, and wherein the measurement apparatus and/or the user device is configured to associate one or more distance values, and/or one or more offset values. with each inferred position to build an array of coordinates of measurements.

28. (canceled)

29. A measurement apparatus comprising:
a body portion; and
an engagement member for engaging a surface, the engagement member located at an end of the body portion;
wherein the measurement apparatus is operable to measure:
a first distance between a reference level and a first point of a surface to be levelled;
a second distance between the reference level and a second point of the surface to be levelled; and
an offset between the first distance and the second distance.

30. A method for preparing a surface to be levelled, the method comprising the steps of:
(i) providing a reference level;
(ii) measuring a first distance between the reference level and a first point of a surface to be levelled;
(iii) measuring a second distance between the reference level and a second point of the surface to be levelled;
(iv) determining an offset between the first distance and the second distance;
(v) providing a levelling member to the second point of the surface, the levelling member being configured, in use when located on the surface, to reduce or eliminate the offset; and
(vi) securing the levelling member to the surface.
